(19) United States
(12) Patent Application Publication
(10) Pub. No.: US 2025/0340737 A1
(43) Pub. Date: Nov. 6, 2025

(54) DENSIFIED BIOMASS-POLYMER COMPOSITES, AND METHODS OF MAKING AND USING THE SAME

(71) Applicant: BurCell Technologies, Inc., Kennesaw, GA (US)

(72) Inventor: Luca ZULLO, Excelsior, MN (US)

(21) Appl. No.: 19/198,781

(22) Filed: May 5, 2025

Related U.S. Application Data
(60) Provisional application No. 63/643,068, filed on May 6, 2024.

(51) Int. Cl. C08L 97/02; C08J 5/00

(52) U.S. Cl. CPC C08L 97/02; C08J 5/00; C08L 2207/062; C08L 2207/066; C08L 2207/20

(57) ABSTRACT

The invention includes densified solid biomass-polymer composites and methods for producing the composites by introduction of a polymer, dissolved in a solvent, to a biomass material prior to densification. Some variations provide a densified solid biomass-polymer composite comprising: from 20 wt % to 98.5 wt % biomass; from 1 wt % to 20 wt % polymer; and from 0.5 wt % to 10 wt % solvent. The biomass, the polymer, and the solvent are intimately mixed together. The densified solid biomass-polymer composite has a higher heating value of at least 8000 Btu/lb. The densified solid biomass-polymer composite is suitable as a solid fuel for combustion, or as a gasification feedstock for making syngas. Methods of making and using the densified solid biomass-polymer composites are disclosed. Examples show the benefit of including a polymer, such as polystyrene, and solvent, such as biodiesel, in the densified biomass composite.

### PRIORITY DATA

This non-provisional patent application claims priority to U.S. Provisional Patent App. No. 63/643,068, filed on May 6, 2024, which is hereby incorporated by reference.

### FIELD

The present invention generally relates to densified solid fuel materials that include renewable biomass, and methods of making and using such materials.

### BACKGROUND

Biomass has been combusted since the discovery of fire hundreds of thousands of years ago. Biomass is a renewable and sustainable fuel, unlike fossil resources such as coal. When biomass is combusted, the CO₂ emitted to the atmosphere is available for photosynthesis to grow new biomass—thereby forming a renewable cycle that does not add net greenhouse gases to the Earth's atmosphere.

In recent years, an industry has developed for biomass pellets that can be shipped more economically compared to raw biomass. Essentially, biomass pellets overcome the naturally low bulk density of native biomass, such as wood and herbaceous biomass. A need remains for better densified biomass fuel materials.

There is value in improving the thermomechanical characteristics of densified biomass fuel materials by improving heating value and combustion characteristics. What is sought is a low-moisture, high-heating-value material that can be used as a densified solid biomass-based fuel, among other uses.

### SUMMARY

Some variations of the invention provide a densified solid biomass-polymer composite comprising:
from about 50 wt % to about 98.5 wt % biomass;
from about 1 wt % to about 20 wt % polymer, wherein the polymer includes a single type of polymer or multiple types of polymers;
from about 0.5 wt % to about 10 wt % solvent,
wherein the biomass, the polymer, and the solvent are intimately mixed together,
and wherein the densified solid biomass-polymer composite has a higher heating value of at least 8000 Btu/lb.

In some embodiments, the biomass is selected from the group consisting of hardwoods, softwoods, herbaceous biomass, agricultural crops, agricultural residues, grasses, municipal solid waste, post-consumer paper, post-consumer cardboard, and combinations thereof.

In some embodiments, the polymer is selected from the group consisting of polystyrene, polyethylene, polypropylene, and combinations thereof. Other polymers may be used, preferably polymers containing only C, H, and O atoms. The polymer may be derived from a post-consumer plastic source.

In some embodiments, the solvent is one or more organic solvents selected from the group consisting of organic esters, ketones, alcohols, aromatics, cyclic alkanes, and combinations thereof. In certain embodiments, the solvent is selected from fatty acid methyl esters. In certain preferred embodiments, the solvent contains or consists essentially of biodiesel.

In some embodiments, the densified solid biomass-polymer composite contains about 8 wt % or less water moisture. In certain embodiments, the densified solid biomass-polymer composite contains about 4 wt % or less water moisture.

In some embodiments, the densified solid biomass-polymer composite has a higher heating value of at least 8250 Btu/lb. In certain embodiments, the densified solid biomass-polymer composite has a higher heating value of at least 8500 Btu/lb.

In some embodiments, the densified solid biomass-polymer composite is in the form of a biomass-polymer pellet. The biomass-polymer pellet may have a pellet density of at least 40 lb/ft³. Other composite forms and geometries are possible. For example, the densified solid biomass-polymer composite may be in the form of a biomass-polymer briquette.

Other variations of the invention provide a method of making a densified solid biomass-polymer composite, the method comprising:
(a) providing biomass;
(b) providing a polymer, wherein the polymer includes a single type of polymer or multiple types of polymers;
(c) providing a solvent that is selected to at least partially dissolve the polymer in the solvent;
(d) mixing the biomass, the polymer, and the solvent in one or more mixing units to generate an intimately mixed material comprising the biomass, the polymer, and the solvent;
(e) feeding the intimately mixed material to a densification unit configured to densify the intimately mixed material into a densified solid biomass-polymer composite; and
(f) recovering the densified solid biomass-polymer composite.

In some methods, the biomass is selected from the group consisting of hardwoods, softwoods, herbaceous biomass, agricultural crops, agricultural residues, grasses, municipal solid waste, post-consumer paper, post-consumer cardboard, and combinations thereof.

In some methods, the polymer is selected from the group consisting of polystyrene, polyethylene, polypropylene, and combinations thereof. In certain methods, the polymer is derived from a post-consumer plastic source, such as municipal solid waste.

In certain preferred method embodiments, the solvent consists essentially of biodiesel.

In some methods, a first mixing unit is employed to mix the polymer and the solvent to generate a polymer-solvent mixture, and a second mixing unit is employed to mix the biomass with the polymer-solvent mixture to generate the intimately mixed material. In other methods, a single mixing unit is employed to mix the polymer, the solvent, and the biomass to generate the intimately mixed material.

In some methods, step (d) utilizes a mixing temperature selected from about 20° C. to about 200° C.

In some methods, the densification unit is a pellet mill, an extruder, or a briquetter. Multiple densification units may be employed, in series or in parallel.

Optionally, a binder may be added to the densification unit. The binder is distinct from the biomass, the polymer, and the solvent. In some embodiments, no distinct binder is added, but the polymer functions as an in situ binder for densification (e.g., pelletization).

In some methods, the densified solid biomass-polymer composite contains about 4 wt % or less water moisture.

In some methods, the densified solid biomass-polymer composite has a higher heating value of at least 8500 Btu/lb.

In some methods, the densified solid biomass-polymer composite is in the form of a biomass-polymer pellet. The biomass-polymer pellet may have a pellet density of at least 40 lb/ft³, for example.

In some methods, the densified solid biomass-polymer composite is in the form of a biomass-polymer briquette.

### BRIEF DESCRIPTION OF THE FIGURES

FIG. 1 is an exemplary sketch of a densified biomass-polymer composite, in some embodiments of the invention.

FIG. 2 is an exemplary block-flow diagram depicting some embodiments of the invention.

### DETAILED DESCRIPTION OF EMBODIMENTS

The materials, methods, processes, systems, and apparatus of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawing.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

In this specification, “polymer” and “plastic” are synonymous terms that refer to a macromolecule composed of repeating structural units (monomers) are linked together by chemical bonds.

In this specification, “biomass” means an organic material that comes originally from living organisms, including plants, animals, and fungi. Biomass is the direct or indirect product of photosynthesis of carbon dioxide, water, and nutrients. In the case of plants such as wood and corn, biomass is the direct product of photosynthesis.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except in the case of a Markush group. Thus in some embodiments not otherwise explicitly recited, any instance of “comprising” may be replaced by “consisting of” or, alternatively, by “consisting essentially of.”

Polystyrene (PS), low-density polyethylene (LDPE), high-density polyethylene (HDPE), and polypropylene (PP) are chemically reduced, hydrophobic polymers that are composed of only carbon and hydrogen atoms. These common polymers are known to have excellent combustion characteristics when properly handled, as well as a high heating value relative to oxygen-rich biomass. PS, LDPE, HDPE, and PP are extensively used in packaging and single-use plastic applications, which renders them readily available and inexpensive in the post-consumer market. Although these polymers can theoretically be recycled, it is practically difficult to achieve high recycling rates due to economical or technical challenges. As such, PS, LDPE, HDPE, and PP commonly end up in landfills, or dispersed in the environment (such as in the form of microplastics that contaminate land and water), which can negatively impact human health. Beneficial uses of these polymers would avoid the need for waste management, reduce landfill volumes, and limit pollution caused by dispersed plastics.

In principle, waste plastics can be directly pelletized. However, pelletizing ground polymer solid fragments into conventional fuel pellets gives rise to a poorly bound material incapable of meeting the mechanical properties required by industry standards. Also, it is prohibitively expensive and inefficient to sort, wash, and grind plastics sufficiently to achieve an adequately isotropic pellet that is made solely from the waste plastics.

By contrast, the disclosed technology provides a new approach to produce densified biomass-polymer composites. Waste plastics, pre-consumer plastics, and/or residual plastics (such as, but not limited to, PS, LDPE, HDPE, and PP) can be dissolved into an organic solvent, and then blended with densification-ready biomass prior to densification. The blended material is used to produce a densified biomass-polymer composite, such as a biomass-polymer pellet. The densification process and blending can employ conventional equipment to produce a product that meets or exceeds recognized market standards.

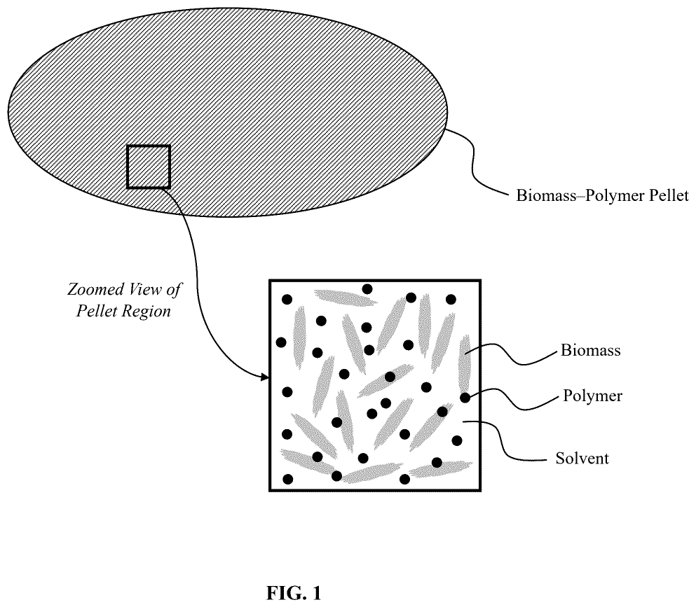

An exemplary biomass-polymer pellet is depicted in FIG. 1. The geometry of the illustrated biomass-polymer pellet is elliptical (a three-dimensional ellipsoid). An arbitrarily selected zoomed-in region is shown for purposes of illustration. The drawing is not to scale. The zoomed view shows elongated particles of biomass (depicted as gray fibers), polymer particles (depicted as black dots), and solvent (depicted as white regions between biomass and polymer). The polymer particles are not necessarily spherical, and they may be partially or completed dissolved in the solvent, or suspended but not dissolved in the solvent.

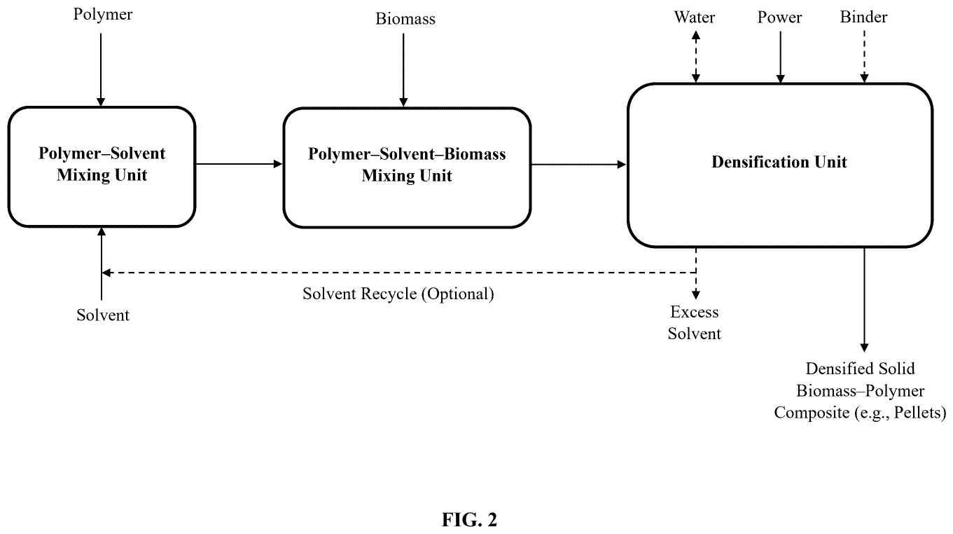

An exemplary method of making a densified solid biomass-polymer composite is depicted in FIG. 2. In this simplified block-flow diagram, a polymer and a solvent are mixed in a polymer-solvent mixing unit. The polymer-solvent mixture is conveyed to a polymer-solvent-biomass mixing unit, into which biomass is also fed. The polymer-solvent-biomass mixture is well-mixed to form an intimately mixed material. The intimately mixed material is fed to a densification unit, such as a pellet mill. Power is applied to the densification unit to cause a mechanical force acting upon the intimately mixed material, for densification. A binder may optionally be added to the densification unit. Water may be withdrawn from the densification unit, such as via steam vents. Alternatively, or additionally, water may be added to the densification unit, as steam or liquid water, to assist the densification. Excess solvent, if any, may be recovered from the densification unit, rather than remaining in the final composite. The excess solvent may be partially or completely recycled to the polymer-solvent mixing unit, displacing the need for fresh solvent. A densified solid biomass-polymer composite is recovered from the densification unit, such as in the form of compacted powder, pellets, briquettes, or another geometry. The method shown in FIG. 2 may be employed to fabricate the biomass-polymer pellet of FIG. 1.

In a variation of the method depicted in FIG. 2, the two mixing units are combined into a single mixing unit. In these variations, a polymer, a solvent, and biomass are mixed in a polymer-solvent-biomass mixing unit. The polymer-solvent-biomass mixture is well-mixed to form an intimately mixed material. The intimately mixed material is fed to a densification unit, such as a pellet mill. Power is applied to the densification unit to cause a mechanical force acting upon the intimately mixed material, for densification. A binder may optionally be added to the densification unit. Water may be withdrawn from the densification unit, such as via steam vents. Alternatively, or additionally, water may be added to the densification unit, as steam or liquid water, to assist the densification. Excess solvent, if any, may be recovered from the densification unit, rather than remaining in the final composite. The excess solvent may be partially or completely recycled to the polymer-solvent mixing unit, displacing the need for fresh solvent. A densified solid biomass-polymer composite is recovered from the densification unit, such as in the form of compacted powder, pellets, briquettes, or another geometry. The method of this variation of FIG. 2 may be employed to fabricate the biomass-polymer pellet of FIG. 1.

Some variations of the invention provide a densified solid biomass-polymer composite comprising:
from about 50 wt % to about 98.5 wt % biomass;
from about 1 wt % to about 20 wt % polymer, wherein the polymer includes a single type of polymer or multiple types of polymers;
from about 0.5 wt % to about 10 wt % solvent,
wherein the biomass, the polymer, and the solvent are intimately mixed together,
and wherein the densified solid biomass-polymer composite has a higher heating value of at least 8000 Btu/lb.

In some embodiments, the biomass is selected from the group consisting of hardwoods, softwoods, herbaceous biomass, agricultural crops, agricultural residues, grasses, municipal solid waste (or a fraction thereof), post-consumer paper, post-consumer cardboard, and combinations thereof. Variations pertaining to municipal solid waste (MSW) are described in more detail at the end of this specification.

Other sources of biomass are possible, such as (but not limited to), algae, inactivated yeast, inactivated bacteria, and animal manure. In the case of living biomass such as yeast and bacteria, the biomass is preferably deactivated or killed prior to use.

In some embodiments, the biomass is woody biomass which is defined as woody plants (e.g., trees), including limbs, tops, needles, leaves, and other woody parts, grown in a forest, woodland, or rangeland environment. An example of wood biomass is pine softwood. In some embodiments, the biomass is herbaceous biomass which is defined as plants that have a non-woody stem and which die back at the end of the growing season. Herbaceous biomass includes grasses, grains, and seeds crops from the food-processing industry and their byproducts that include such as cereal straw, hulls, and chaff. An example of herbaceous biomass is corn stover.

In some embodiments, the polymer is one that contains only carbon and hydrogen atoms. For example, the polymer may be a polyolefin, a single-ring aromatic polymer (such as polystyrene), or a polyaromatic (e.g., 3,4-benzopyrene).

In some embodiments, the polymer is selected from the group consisting of polystyrene, polyethylene, polypropylene, and combinations thereof. Various forms of these polymers may be used. For example, polystyrene may be expanded polystyrene, which is a thermoplastic foam material produced from solid beads of polystyrene. Polyethylene may be low-density polyethylene (LDPE), high-density polyethylene (HDPE), or a combination thereof. A common use of LDPE is plastic shopping bags, while a common use of HDPE is milk jugs. Similarly, polypropylene may be low-density polypropylene (LDPP), high-density polypropylene (HDPP), or a combination thereof. Various copolymers may be used as well. For example, the polymer may be a styrene-butadiene copolymer, which is a polymer that contains only carbon and hydrogen atoms.

In some embodiments, the polymer is one that contains carbon, hydrogen, and oxygen atoms. Common polymers in this class include, but are not limited to, polyethylene terephthalate (PET), polycarbonate (PC), polyoxymethylene (POM), polylactic acid (PLA), and polyhydroxyalkanoates (PHAs). The advantage of this class of polymers, compared to polymers that contain elements besides C, H, and O, is that upon combustion there is less potential for toxic emissions. In the case of PLA and PHAs, because these polymers are themselves made from renewable biomass (such as corn), the densified solid biomass-polymer composite may have a higher environmental score compared to fossil resource-based polymers. (Even PS, LDPE, HDPE, and PP can all in principle be made starting with biomass, rather than from crude oil or natural gas. Ethanol from sugar fermentation can be dehydrated to ethylene, for making polyethylene, for example.)

In certain less-preferred embodiments, the polymer contains carbon, hydrogen, and oxygen atoms, and at least one additional atom, such as nitrogen or chlorine. An exemplary nitrogen-containing polymer is nylon, a polyamide polymer. An exemplary chlorine-containing polymer is polyvinyl chloride (PVC). Combustion of these polymers can generate NOₓ and HCl, respectively, which are toxic gases. Note that a mixture of polymers used as the polymer component may contain some amount of polymers such as PVC or nylon, especially in the case of waste plastics (e.g., derived from MSW), as long as most of the polymer content contains only C, H, and optionally O atoms.

The polymer may be derived from a post-consumer plastic source, which may be obtained from a waste-management company, a recycling company, or directly from consumers, for example. The polymer may be obtained from municipal solid waste. Variations pertaining to MSW are described in more detail at the end of this specification.

In some embodiments, the solvent is one or more organic solvents selected from the group consisting of organic esters, ketones, alcohols, aromatics, cyclic alkanes, and combinations thereof. In certain embodiments, the solvent is selected from fatty acid methyl esters. In certain preferred embodiments, the solvent contains or consists essentially of biodiesel. In some embodiments, the solvent is selected from organic esters, such as vegetable oil (e.g., soybean oil).

In some embodiments, the solvent is chosen based on a combination of factors including the polymer solubility, multiple polymer solubility factors, solvent flash point, and/or solvent vapor pressure. In some embodiments, it is preferred to select a solvent with characteristics that limit the risk of ignition during densification. In some embodiments, it is preferred that the solvent be selected based on the amount of vapor released from the finished composite product during storage or handling.

In some embodiments, the solvent is highly reduced chemically, i.e. the solvent molecule contains little or no oxygen atoms. Preferably, the solvent is not toxic. Preferably, the solvent is bio-based. Preferably, the solvent is widely available.

A solvent class that meets all these preferences is fatty acid methyl esters (“FAME”). Within the class of FAME solvents, the solvent may specifically be biodiesel. Biodiesel is a renewable fuel produced through transesterification, in which fatty acids in oils or fats are converted into esters (specifically, methyl esters). The term “biodiesel” in this specification refers to a material that meets all specifications under ASTM D6751-20a “Standard Specification for Biodiesel Fuel Blend Stock (B100) for Middle Distillate Fuels”, which is hereby incorporated by reference. Biodiesel is therefore a type of FAME, while other types of FAME that do not qualify as biodiesel under ASTM D6751 may nevertheless be used as the solvent in this technology. In some embodiments, the solvent consists essentially of biodiesel, which means that impurities may be present but that the functional solvent is biodiesel. In some embodiments, the solvent comprises biodiesel and one or more other co-solvents, such as organic esters, ketones, alcohols, aromatics, or cyclic alkanes.

In some embodiments, the densified solid biomass-polymer composite contains about 8 wt % or less water moisture. In certain embodiments, the densified solid biomass-polymer composite contains about 4 wt % or less water moisture. In various embodiments, the densified solid biomass-polymer composite contains about, or at most about 10, 9, 8, 7, 6, 5, 4, 3, 2, 1, 0.5, 0.2, 0.1, or 0 wt % water moisture, including any intervening range. The moisture usually comes from water moisture contained in the biomass, rather than being intentionally added, or coming from the polymer or the solvent. For example, the moisture of the wood commonly used in wood fuel pellets often varies between 5 wt % and 15 wt %. It is usually not economical to completely dry the wood, when that is the selected biomass. However, for certain types of biomass, the moisture content may be very low. In these embodiments, the densified solid biomass-polymer composite may contain less than 4 wt %, less than 3 wt %, less than 2 wt %, or less than 1 wt % water moisture.

In some embodiments, the densified solid biomass-polymer composite has a higher heating value of at least 8250 Btu/lb. In certain embodiments, the densified solid biomass-polymer composite has a higher heating value of at least 8500 Btu/lb. In various embodiments, the densified solid biomass-polymer composite has a higher heating value of about, or at least about 7500, 7600, 7700, 7800, 7900, 8000, 8050, 8100, 8150, 8200, 8250, 8300, 8350, 8400, 8450, 8500, 8600, 8700, 8800, 8900, or 9000 Btu/lb, including any intervening range.

In some embodiments, the densified solid biomass-polymer composite has a higher heating value of at least 7600 Btu/lb. In various embodiments, the densified solid biomass-polymer composite has a higher heating value of about, or at least about 7100, 7200, 7300, 7400, 7500, 7600, 7700, 7800, 7900, 8000, 8100, 8200, 8300, 8400, 8500, or 8600 Btu/lb, including any intervening range.

In some embodiments, the densified solid biomass-polymer composite is in the form of a biomass-polymer pellet. The biomass-polymer pellet may have a pellet density of at least 40 lb/ft³. Other composite forms and geometries are possible. For example, the densified solid biomass-polymer composite may be in the form of a biomass-polymer briquette.

The densified solid biomass-polymer composite may be characterized by a durability index, such as a pellet durability index when the composite is in the form of a pellet. For example, the Kansas State Pellet Durability Index prescribes tumbling 500 grams of cooled pellets in a durability tumbler for 10 minutes at 50 revolutions per minute. Pellets are then sieved according to their starting diameter, allowing fines to pass through. The retained pellets are weighed and a percent durability calculated. The PDI ranges from 100% (no fines lost from tumbling) to 0% (all pellets fall apart into fines). Preferably, biomass-polymer pellets have a PDI of at least about 90%, more preferably at least about 95%, even more preferably at least about 97%, and most preferably at least about 98%. A similar durability index may be used for biomass-polymer briquettes or other densified objects.

The densified solid biomass-polymer composite may be characterized by moisture uptake, measured by sorbency. For example, the sorbency of the densified solid biomass-polymer composite may be measured according to ASTM F726-99; 9.3.2 Type II sorbents, which is hereby incorporated by reference. Reduction of hygroscopicity is valuable to reduce risk of moisture uptake during storage and transportation of the densified biomass-polymer composite, thereby simplifying transport and storage of the composite. The inclusion of a hydrophobic polymer and/or a hydrophobic solvent can reduce water absorption, which means reduced hygroscopicity. The densified solid biomass-polymer composite becomes less susceptible to taking up water in the supply chain. Furthermore, a better heating value is maintained when combusting the densified solid biomass-polymer composite. When the composite is too hygroscopic, a lot of moisture can be taken up in the supply chain; consequently, the heating value of the composite is reduced, because energy is used to evaporate absorbed/adsorbed water.

Other variations of the invention provide a method of making a densified solid biomass-polymer composite, the method comprising:
(a) providing biomass;
(b) providing a polymer, wherein the polymer includes a single type of polymer or multiple types of polymers;
(c) providing a solvent that is selected to at least partially dissolve the polymer in the solvent;
(d) mixing the biomass, the polymer, and the solvent in one or more mixing units to generate an intimately mixed material comprising the biomass, the polymer, and the solvent;
(e) feeding the intimately mixed material to a densification unit configured to densify the intimately mixed material into a densified solid biomass-polymer composite; and
(f) recovering the densified solid biomass-polymer composite.

In some methods, the biomass is selected from the group consisting of hardwoods, softwoods, herbaceous biomass, agricultural crops, agricultural residues, grasses, municipal solid waste, post-consumer paper, post-consumer cardboard, and combinations thereof.

In some methods, the polymer is selected from the group consisting of polystyrene, polyethylene, polypropylene, and combinations thereof. In certain methods, the polymer is derived from a post-consumer plastic source.

In some methods, the solvent is selected from the group consisting of organic esters, ketones, alcohols, aromatics, cyclic alkanes, and combinations thereof. In certain embodiments, the solvent is selected from fatty acid methyl esters. In certain preferred embodiments, the solvent contains or consists essentially of biodiesel.

In some methods, the solvent is chosen based on a combination of factors including the polymer solubility, multiple polymer solubility factors, solvent flash point, and/or solvent vapor pressure. In some embodiments, it is preferred to select a solvent with characteristics that limit the risk of ignition during densification. In some embodiments, it is preferred that the solvent be selected based on the amount of vapor released from the finished composite product during storage or handling. Preferably, the solvent is not toxic, is bio-based, and is widely available (relatively low cost).

In some preferred methods, the selected solvent consists essentially of biodiesel. Biodiesel is a renewable fuel produced through transesterification, in which fatty acids in oils or fats are converted into esters (specifically, methyl esters). In certain methods, the solvent consists essentially of biodiesel, which means that impurities may be present but that the functional solvent is solely biodiesel. In other embodiments, the solvent comprises biodiesel and one or more other co-solvents, such as organic esters, ketones, alcohols, aromatics, or cyclic alkanes. Biodiesel is an advantageous solvent for many reasons. It is non-toxic, made from renewable feedstocks, is widely available. Polystyrene has been proven to be highly and rapidly soluble into biodiesel at room temperature, which is very convenient. Polyolefins such as polypropylene and polyethylene require a higher temperature and longer processing times to dissolved the polymers with biodiesel. Nonetheless, these temperatures do not exceed 200° C. and therefore remain below the flash point of biodiesel or conditions in which biodiesel vapors are of concern. Finally, although biodiesel contains oxygen (typically around 10 wt %), it has good fuel characteristics. When the final densified solid biomass-polymer composite is combusted, the biodiesel efficiently combusts along with the biomass and the polymer.

In some variations, one or more polymers are dissolved into a suitable solvent, which is preferably an organic solvent. The solvent may decrystallize the polymer, thereby solubilizing some or all of the polymer into the solvent. The result is a higher-viscosity fluid polymer-solvent mixture suitable for blending with biomass to form an intimately mixed material that is fed into a densification unit. Under the operating conditions in the densification unit, the biomass may absorb at least a portion of the solvent.

In some embodiments, the production of the polymer-solvent mixture entails contacting a selected polymer with a selected solvent at a temperature which may be as high as about 200° C. with mixing. The solubilization process may continue until no solid is visible, or until the maximum solubility limit has been reached for the specific conditions, for example.

In some embodiments, in order to facilitate the dissolution of the polymer into the solvent, an excess of solvent may be used. In this specification, “excess solvent” means a concentration of solvent that exceeds the concentration at the maximum solubility limit for the selected polymer in the selected solvent. There are various reasons for utilizing excess solvent during processing, such as for better mass transfer (intimate mixing), to maintain a slurry rather than solids processing, or to act as a lubricant during processing, for example. When an excess of solvent is used, the weight percentage of solvent in an intermediate material can exceed 5 wt %. During processing, excess solvent is eventually removed such that the final densified solid biomass-polymer composite contains a maximum of about 5 wt % solvent.

In certain embodiments, it is desirable to limit the total amount of solvent as measured by percent weight in the final densified solid biomass-polymer composite, with a percent weight of polymer that is in excess of the theoretical maximum solubility limit for the specific amount of select solvent. In embodiments in which the polymer-to-solvent ratio is in excess of the maximum solubility ratio for the selected polymer and solvent, it may be desirable to recover some portion (or all) of the fully dissolved polymer from a portion of a polymer-solvent mixture. For example, dissolved polymer may be recovered from the solvent through the use of an antisolvent. Excess solvent may be recovered and recycled for reuse. In some embodiments, a stream containing both polymer and solvent is recycled to the polymer-solvent mixing unit. That recycle stream may also contain small particles (e.g., fines) of biomass, which has another opportunity to be densified in the densification unit after being recycled. The small particles of biomass may originate from a stream directly recycled from the densification unit, or from downstream handling of the densified composite (such as pellet handling), for example.

In some embodiments, polymer is recovered from solvent by use of a suitable antisolvent. Generally, an antisolvent works by reducing the solubility of a solute in a solution, thus inducing separation. By adding an antisolvent in which the solute is less soluble compared to the solvent, the solution becomes supersaturated with the solute, leading to crystal formation. In this technology, exemplary antisolvents include, but are not limited to, water, aliphatic hydrocarbons (e.g., alkanes such as n-hexane), olefinic hydrocarbons (e.g., cyclohexene), aromatic hydrocarbons (e.g., toluene), or a combination thereof. In a specific embodiments, the antisolvent is petroleum-derived diesel. The choice of antisolvent will typically depend on the type of solvent as well as type of polymer.

An antisolvent may be added to a mixture of polymer and solvent, such as the “excess solvent” from the densification unit shown in FIG. 2 (that stream may contain non-densified polymer), or another mixture available in the process. The weight ratio of antisolvent to solvent may vary, such as from about 2 to about 0.5, depending on the antisolvent chosen and the concentration on the dissolved polymer. After a suitable mixing time (such as about 1-30 minutes), and possibly at an elevated temperature (such as about 30-100° C.), the antisolvent causes some or all of the polymer to crash out of solution, i.e. no longer be dissolved by the solvent. The polymer may be recovered and reused in the polymer-solvent mixing unit, if desired. Also, the solvent may be separated from the antisolvent, after which the solvent may be reused in the polymer-solvent mixing unit.

In step (d), various types of mixing units may be employed to intimately mix the biomass, the polymer, and the solvent. The mixing unit may be selected from drum mixers, high-shear mixers, ribbon blenders, paddle mixers, static mixers, planetary mixers, convective mixers, double-cone mixers, tumbler mixers, tank mixers, blenders, homogenizers, extruders, or a combination thereof, for example. The mixing unit is preferably not a simple tank that relies on only diffusion for mixing. Rather, the mixing unit preferably includes agitation means to cause turbulence and therefore convection. The agitation means may be an agitator, an impeller, or a static mixing element, for example. A static mixing element is inside a pipe and disrupts fluid flow to create turbulence, promoting mixing without the need for moving parts. Static mixing element, such as twisted blades or baffles, cause fluids to divide, recombine, and interact, leading to a homogenous mixture.

In some methods, a first mixing unit is employed to mix the polymer and the solvent to generate a polymer-solvent mixture, and a second mixing unit is employed to mix the biomass with the polymer-solvent mixture to generate the intimately mixed material. In other methods, a single mixing unit is employed to mix the polymer, the solvent, and the biomass to generate the intimately mixed material. It is also possible for there to be three or more mixing units.

In some methods, step (d) utilizes a mixing temperature selected from about 20° C. to about 200° C. In various embodiments, the mixing temperature is about, at least about, or at most about 20° C., 25° C., 30° C., 40° C., 50° C., 60° C., 70° C., 80° C., 90° C., 100° C., 110° C., 120° C., 130° C., 140° C., 150° C., 160° C., 170° C., 180° C., 190° C., or 200° C., including any intervening range. Multiple mixing temperatures, or a range of mixing temperature, may be used. For example, a mixing temperature profile may be used in which mixing is performed while the temperature ramps up from about 25° C. to about 75° C., and then the temperature ramps back down from about 75° C. to about 25° C., to complete the mixing step. These temperatures are solely for illustration. If the densification unit is operating at an elevated temperature that exceeds the temperature of the mixing unit, it is usually not necessary to cool the intimately mixed material prior to feeding to the densification unit.

When two mixing units are employed, such as shown in FIG. 2, the mixing temperature in the first mixing unit may be the same as, or different than, the mixing temperature in the second mixing unit. In various embodiments employing a first and second mixing unit, the mixing temperature in the first mixing unit is about, at least about, or at most about 20° C., 25° C., 30° C., 40° C., 50° C., 60° C., 70° C., 80° C., 90° C., 100° C., 110° C., 120° C., 130° C., 140° C., 150° C., 160° C., 170° C., 180° C., 190° C., or 200° C., including any intervening range; and the mixing temperature in the second mixing unit, independently from the first mixing unit, is about, at least about, or at most about 20° C., 25° C., 30° C., 40° C., 50° C., 60° C., 70° C., 80° C., 90° C., 100° C., 110° C., 120° C., 130° C., 140° C., 150° C., 160° C., 170° C., 180° C., 190° C., or 200° C., including any intervening range. For each mixing unit, multiple mixing temperatures, or a range of mixing temperature, may be used. For example, a first mixing temperature profile may be used for the first mixing unit in which mixing is performed while the temperature ramps up from about 25° C. to about 75° C., to complete the first mixing step; and then a second mixing temperature profile may be used for the second mixing unit in which mixing is performed while the temperature ramps up from about 75° C. to about 100° C., and then the temperature ramps back down from about 100° C. to about 25° C., to complete the second mixing step. These temperatures are solely for illustration. If the densification unit is operating at an elevated temperature that exceeds the temperature of the second mixing unit, it is usually not necessary to cool the intimately mixed material prior to feeding to the densification unit.

The mixing time in a mixing unit may vary widely, such as from on the order of seconds in the case of static mixers, to minutes or hours in the case of units with impellers or agitators. For a batch mixer, the mixing time is the batch time. For a continuous mixer, the mixing time is the mean residence time in the mixing unit. In various embodiments, the mixing time is about, at least about, or at most about 10 seconds, 30 seconds, 1 minutes, 2 minutes, 5 minutes, 10 minutes, 15 minutes, 30 minutes, 45 minutes, 1 hour, 2 hours, 4 hours, or 8 hours, including any intervening range. When there are two mixing units, each mixing unit has an independently selected mixing time.

The mixing in a mixing unit may be carried out at atmospheric pressure. Alternatively, the mixing may be carried out under vacuum, or under an elevated pressure, such as about 1.5 bar, about 2 bar, about 2.5 bar, or higher.

The selected solvent at the mixing temperature will have a vapor pressure, and it is usually not desired to allow the solvent to escape from the mixing unit. Thus the mixing unit is preferably closed to the atmosphere. However, when using a solvent such as biodiesel, the vapor pressure at room temperature is so low that when mixing at 25° C. is performed, and if the mixing time is relatively short, an open mixing unit can be used as long as suitable safety considerations are in place.

In some methods, the densification unit is a pellet mill, an extruder, or a briquetter. The densification unit operates primarily by applying physical force to the intimately mixed biomass-polymer-solvent, thereby increasing density. The densification may be assisted by elevated temperature, use of a densification agent such as steam, or addition of a binder, for example. Multiple densification units may be employed, in series or in parallel.

A pellet mill is a typical densification unit. A pellet mill, also known as a pellet press, is an apparatus used to create pellets from incoming material. There are many types of pellet mills that can be generally grouped into large-scale pellet mills and small-scale pellet mills. According to the production capacity, pellet mills also can be divided into flat-die pellet mills and ring-die pellet mills. Any of these types of pellet mills may be employed as the densification unit in this disclosure.

When an extruder is used as the densification unit, the extruder may be a single-screw extruder or a twin-screw extruder. A twin-screw extruder may be a co-rotating twin-screw extruder, a counter-rotating twin-screw extruder, or another type of twin-screw extruder that is typically operated continuously. A twin-screw extruder that is operated in batch or semi-batch mode is typically referred to as a twin-rotor mixer. The extruder applies mechanical force to convert the intimately mixed biomass-polymer-solvent material into extrudates or pellets of the densified solid biomass-polymer composite.

When a briquetter is used as the densification unit, the intimately mixed biomass-polymer-solvent material is fed to the briquetter, such as through a hopper. A screw conveyor or other means moves the intimately mixed material from the hopper to the compression chamber. High pressure is applied to the intimately mixed material, such as through a screw press or hydraulic press, causing it to compact and form a dense mass. The compressed material is forced through a die or mold, giving the briquettes their desired shape and size. Finished briquettes are ejected from the briquetter, either manually or automatically, resulting in briquettes of the densified solid biomass-polymer composite.

The densification unit may be operated at about 25° C., or at an elevated temperature, up to about 200° C., for example. A typical temperature range in the densification unit is from about 50° C. to about 100° C. In various embodiments, the densification temperature is about, at least about, or at most about 25° C., 30° C., 35° C., 40° C., 50° C., 60° C., 70° C., 80° C., 90° C., 100° C., 110° C., 120° C., 130° C., 140° C., 150° C., 160° C., 170° C., 180° C., 190° C., or 200° C., including any intervening range.

Optionally, a binder may be added to the densification unit. The binder is distinct from the biomass, the polymer, and the solvent. Exemplary binders include lignin, phenolic materials, starch, vegetable oil, wax, biomass tar from gasification, biomass pyrolysis oil, or a combination thereof.

In some embodiments, no distinct binder is added, but the polymer functions as an in situ binder for densification (e.g., pelletization). For example, a dispersed plastic material (e.g., polyethylene which melts around 110° C.) may melt during processing (e.g., in a mixing unit) and then, upon cooling and solidification, the solidified plastic material functions as a binder. Note, however, that melting and solidification is not necessary for a material to function as an in situ binder. Even a softened, but unmelted, polymer may work as a binder if there is partial dissolution of the polymer in the solvent such that polymer segments are able to penetrate to internal surfaces within the composite and bind those surfaces together.

In some methods, the densified solid biomass-polymer composite contains about 8 wt % or less water moisture. In certain embodiments, the densified solid biomass-polymer composite contains about 4 wt % or less water moisture. In various embodiments, the densified solid biomass-polymer composite contains about, or at most about 10, 9, 8, 7, 6, 5, 4, 3, 2, 1, 0.5, 0.2, 0.1, or 0 wt % water moisture. It can be beneficial to have fairly high moisture during densification, such as when making pellets, then allowing steam release from the final pellets to dry them at least to some extent. In some preferred embodiments, the densification unit (e.g., a pelletizer) takes in a mixture having from about 8 wt % to about 20 wt %, such as from about 12 wt % to about 15 wt %, water moisture. If the mixture has less than the desired moisture, either moisture can be added to the mixture prior to it entering the densification unit, or steam or water may be injected directly into the densification unit. In the case of a pellet mill, for example, the use of steam for pelletizing improves pelletizing efficiency along with reducing die wear while having limited to no impact on final pellet moisture when cooled.

In some methods, the densified solid biomass-polymer composite has a higher heating value of at least 8250 Btu/lb or at least 8500 Btu/lb. In various embodiments, the densified solid biomass-polymer composite has a higher heating value of about, or at least about 7100, 7200, 7300, 7400, 7500, 7600, 7700, 7800, 7900, 8000, 8050, 8100, 8150, 8200, 8250, 8300, 8350, 8400, 8450, 8500, 8600, 8700, 8800, 8900, or 9000 Btu/lb, including any intervening range.

In some methods, the densified solid biomass-polymer composite is in the form of a biomass-polymer pellet. The biomass-polymer pellet may have a pellet density of at least 40 lb/ft³, for example. In various embodiments, the biomass-polymer pellet has a pellet density of about, at least about, or at most about 25 lb/ft³, 30 lb/ft³, 35 lb/ft³, 40 lb/ft³, 45 lb/ft³, or 50 lb/ft³, including any intervening range.

The biomass-polymer pellet may be spherical, cylindrical, elliptical (e.g., see FIG. 1), or another pellet shape. The dimensions of a biomass-polymer pellet may vary widely. The biomass-polymer pellet may be characterized by a pellet diameter, which is the sphere diameter when the pellet is spherical, the cylinder diameter when the pellet is cylindrical, the short axis when the pellet is elliptical, and the effective diameter for other arbitrary shapes. The average biomass-polymer pellet diameter may be about, at least about, or at most about 0.1, 0.15, 0.2, 0.25, 0.3, 0.35, 0.4, 0.45, 0.5, 0.6, 0.7, 0.8, 0.9, or 1 inches, including any intervening range. When the biomass-polymer pellet is non-spherical, it is also characterized by a pellet length. The pellet length is the cylinder length when the pellet is cylindrical, the long axis when the pellet is elliptical, and the maximum length scale for other arbitrary shapes. The average biomass-polymer pellet length may be about, at least about, or at most about 0.25, 0.5, 0.75, 1, 1.25, 1.5, 1.75, 2, 2.25, or 2.5 inches, including any intervening range.

The biomass-polymer pellet may be characterized by a pellet durability index (“PDI”). The Kansas State Pellet Durability Index (“Kansas State PDI”) is preferably used, which prescribes tumbling 500 grams of cooled pellets in a durability tumbler for 10 minutes at 50 revolutions per minute. Pellets are then sieved according to their starting diameter, allowing fines to pass through. The retained pellets are weighed and a percent durability calculated. The PDI ranges from 100% (no fines lost from tumbling) to 0% (the pellets completely fall apart). Preferably, the biomass-polymer pellets have a Kansas State PDI of at least about 90%, more preferably at least about 95%, even more preferably at least about 97%, and most preferably at least about 98%.

In some methods, the densified solid biomass-polymer composite is in the form of a biomass-polymer briquette. The biomass-polymer briquette may have a briquette density of at least 30 lb/ft³, for example. In various embodiments, the biomass-polymer briquette has a pellet density of about, at least about, or at most about 20 lb/ft³, 25 lb/ft³, 30 lb/ft³, 35 lb/ft³, or 40 lb/ft³, including any intervening range.

The biomass-polymer briquette may be spherical, cylindrical, elliptical, or another briquette shape. A typical briquette is pillow-shaped. The dimensions of a biomass-polymer briquette may vary widely. The biomass-polymer briquette may be characterized by a briquette diameter, which is the sphere diameter when the briquette is spherical, the cylinder diameter when the briquette is cylindrical, the short axis when the briquette is elliptical, and the effective diameter for other arbitrary briquette shapes. The average biomass-polymer briquette diameter, length, width, or thickness may be about, at least about, or at most about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 inches, including any intervening range.

In some methods, the densified solid biomass-polymer composite is in the form of a biomass-polymer powder. The biomass-polymer powder contains biomass-polymer particles that may vary in particle size. The average particle size of the biomass-polymer particles may be from about 10 microns to about 1000 microns, such as from about 50 microns to about 500 microns, for example. In various embodiments, the average particle size of the biomass-polymer particles is about, at least about, or at most about 10, 25, 50, 75, 100, 150, 200, 250, 300, 400, 500, 600, 700, 800, 900, or 1000 microns, including any intervening range. The biomass-polymer particles may have a unimodal, bimodal, or polymodal particle-size distribution.

Particle sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

When the densified solid biomass-polymer composite is in the form of a biomass-polymer powder, the powder particles are compressed together, but not bound together to make a pellet or other object. The compressed powder particles may remain relatively free-flowing, or they may be cast as an object, such as sheets, slabs, rings, rods, needles, or another geometry. The compressed powder particles form a composite that may have a composite density of about, at least about, or at most about 25 lb/ft³, 30 lb/ft³, 35 lb/ft³, 40 lb/ft³, or 45 lb/ft³, including any intervening range, for example. The composite density is the bulk density as measured, including porosity (spaces between particles). The intrinsic density of a single biomass-polymer particle will usually be higher, such as from about 50 lb/ft³ to about 90 lb/ft³, based on the respective densities of biomass, polymer, and solvent used and the concentrations of those components in the particle. It is conceptually also possible to compress individual biomass-polymer particles (micro-densification) to increase the particle density, but this is typically not economical.

The densified solid biomass-polymer composite, in various forms, may be industrially used in a large number of ways. Broadly, these include combustion to generate energy for heat, electricity, or both heat and electricity; gasification to produce syngas; process additives; engineered materials; and feedstock for carbon sequestration, to name a few.

Typically, the densified solid biomass-polymer composite is combusted to produce electricity, in direct combustion in the boiler of a power plant, or in co-firing in a coal plant, for example. Biomass-polymer pellets as disclosed herein may be fed to existing biomass power plants or in facilities that have been modified to burn biomass pellets, for example.

In some embodiments, the densified solid biomass-polymer composite is gasified to make syngas, which is a mixture of H₂ and CO. For example, the biomass-polymer pellets as disclosed herein may be fed to existing biomass gasifiers plants or in coal gasifiers that have been modified to gasify biomass pellets, for example. The syngas may be utilized in a number of ways. Syngas can be chemically converted into methane, olefins (such as ethylene), oxygenates (such as dimethyl ether), alcohols (such as ethanol), paraffins, linear or branched C₅-C₁₅ hydrocarbons, diesel fuel, gasoline, or waxes, such as by Fischer-Tropsch chemistry. Syngas can be converted into isobutane by isosynthesis. Syngas can be converted to aldehydes and alcohols by oxosynthesis. Syngas can be converted to methanol as an intermediate for making methanol derivatives including dimethyl ether, acetic acid, ethylene, propylene, or formaldehyde. Syngas can also be converted to energy using energy-conversion devices such as solid-oxide fuel cells, Stirling engines, micro-turbines, internal combustion engines, thermo-electric generators, scroll expanders, gas burners, or thermo-photovoltaic devices.

The densified solid biomass-polymer composite may qualify for various green premiums, credits, and certificates worldwide. The biomass component is almost always recognized as a renewable feedstock. The solvent may be a renewable feedstock, such as biodiesel. The polymer may or may not qualify as a renewable material, but it may qualify under certain incentives since use of the polymer in the composite prevents the polymer going to a landfill, for example. Any product produced from the densified solid biomass-polymer composite, such as electricity, may also qualify for various green premiums, credits, and certificates worldwide. One example is green electricity. Another example is green syngas.

Some variations of the invention provide systems configured to carry out any of the disclosed methods. The block-flow diagram of FIG. 2 may also be considered to be a diagram of a system that includes a polymer-solvent mixing unit in flow communication with a polymer-solvent-biomass mixing unit, which in turn is in communication with a densification unit (e.g., a pellet mill or a briquetter).

Some variations provide a method of system configured for making a densified solid biomass-polymer composite, the system comprising:
one or more mixing units configured for mixing biomass, a polymer, and solvent, wherein the solvent that is selected to at least partially dissolve the polymer, to generate an intimately mixed material comprising the biomass, the polymer, and the solvent; and
a densification unit in flow communication with the one or more mixing units, wherein the densification unit is configured to densify the intimately mixed material into a densified solid biomass-polymer composite.

The mixing units may be selected from drum mixers, high-shear mixers, ribbon blenders, paddle mixers, static mixers, planetary mixers, convective mixers, double-cone mixers, tumbler mixers, tank mixers, blenders, homogenizers, extruders, or a combination thereof, for example.

The densification unit may be selected from a pellet mill, an extruder, a briquetter, or combinations thereof. Multiple densification units may be employed, in series or in parallel.

A system may include a sub-system for adjusting temperature, pressure, and/or residence time within a unit, such as a mixing unit or the densification unit. A sub-system may be configured to vary parameters, such as over a prescribed protocol, or in response to measured variables. For example, an unintended change in densification unit pressure may be compensated by a change in densification unit temperature. As another example, mixing temperature may be maintained constant (isothermal operation) or densification pressure may be maintained constant (isobaric operation). The sub-system may utilize well-known control logic principles, such as feedback control and feedforward control. Control logic may incorporate results from previous experiments or production campaigns.

In some embodiments, solvent concentration within the densification unit may be measured using a gas probe to extract a sample, which is then analyzed using a suitable technique, such as gas chromatography, GC; mass spectroscopy, MS; GC-MS, or Fourier-Transform Infrared Spectroscopy, FTIR.

Safety considerations may be applied to the methods and systems. A unit may include protective devices (e.g., a safety release valve) that automatically activate when the temperature or pressure exceeds a maximum value, for example. Practical safety-related design may be built into the system as well. Those skilled in the art will understand how to design safe units.

In some embodiments, the system input is in flow communication with a storage tank or other storage unit that received a biomass stream and/or a polymer stream, such as from another site, which may be one or more co-located adjacent sites.

The recited method and system options and embodiments may be utilized entirely or partially. Some embodiments may omit method steps or system components. Some embodiments include other method steps or system components that are not explicitly taught herein but are conventional in the chemical-engineering and biorefinery arts. Solid, liquid, and gas streams produced or existing within the biorefinery can be independently recycled, passed to subsequent steps, or removed/purged from the process at any point.

The throughput, or process capacity, can vary widely from small experimental units to full operations, including any pilot, demonstration, or semi-commercial scale. In various embodiments, the process capacity (for feedstocks, products, or both) is at least about 0.1 tons/day (all tons are metric tons), 1 ton/day, 10 tons/day, 100 tons/day, 500 tons/day, 1000 tons/day, 2000 tons/day, or higher.

The composite production plant may be a retrofit to an existing plant. In other embodiments, the composite production plant is a greenfield plant. As will be appreciated by a person skilled in the art, the principles of this disclosure may be applied to many plant configurations beyond those explicitly disclosed or described in the drawings hereto. Various combinations are possible and selected embodiments from some variations may be utilized or adapted to arrive at additional variations that do not necessarily include all features disclosed herein.

Some embodiments utilize a business system in which steps of a method are practiced at different sites and potentially by different corporate entities, acting in conjunction with each other in some manner, such as in a joint venture, an agency relationship, a toll producer, a customer with restricted use of product, etc. For example, densified composite pellets may be produced at a first site to generate a product that is then sent to a second site for producing electricity from the pellets.

### Use of MSW to Create Densified Solid Biomass-Polymer Composites

Some variations that are specific to municipal solid waste will now be described in more detail, without limiting the scope of the technology.

Some embodiments are predicated the use of a usable fiber material from waste cellulose-rich feedstocks in the form of municipal solid waste, or contained within municipal solid waste. In this specification, “municipal solid waste” (“MSW”) means solid waste generated by households, businesses, institutions, and other municipal activities. MSW commonly includes paper and paper products, plastics, food waste and other organics, metals, glass, fabrics, and other materials.

A MSW feedstock may be obtained and subjected to primary sorting and coarse size reduction. In this step, extraneous materials and a significant amount of non-cellulose-rich materials are removed from the MSW feedstock. The size reduction is coarse, typically not below several inches of a characteristic dimension unless the material is already procured with a smaller size. This step may include a variety of sub-steps, such as magnet and eddy current separation to remove ferrous and non-ferrous metals, respectively; and gravimetric screening to remove dirt, grit, sand, stones, and glass. In some embodiments, optical screening is used to remove recyclable plastics. In other embodiments, the plastics are not screened out, but rather used (at least to some extent) as the polymer component of the densified composite.

The prescreened material may then be fed into a reactor, such as a vacuum steam-explosion vessel comprising an externally heated vessel whose contents are mixed by an internal mixer, conveyance, rotation of the vessel, or a combination thereof. The vessel contents are mixed throughout the reactor operations, whether batch, continuous, or semi-batch.

A vacuum steam-explosion vessel may be a heated rotary reactor, for example. The vacuum steam-explosion vessel may contain an internal mixer. The vacuum steam-explosion vessel may be mixed via conveyance (e.g., internal agitation) of contents therein. The vacuum steam-explosion vessel may be mixed via rotation of the vacuum steam-explosion vessel. The vacuum steam-explosion vessel may be operated continuously, semi-continuously, or batch-wise.

A vacuum steam-explosion vessel may be a BurCell® system, such as a BurCell® Heater Rotary Reactor or a similarly designed device. In embodiments employing a BurCell® system, reference is made to U.S. Patent No. 11,458,414, issued on Oct. 4, 2022; U.S. Pat. No. 8,034,132, issued on Oct. 11, 2011; U.S. Pat. No. 7,497,392, issued on Mar. 3, 2009; and Emerson et al., “Chemical Characterization and Conversion Assessment of BurCell® System Treated MSW Materials”, Idaho National Laboratory, CRADA No. 17-CR-01, Report No. INL/EXT-17-43190, September 2017, each of which is hereby incorporated by reference.

The reactor operations may consist of the following sub-steps. A controlled amount of cellulose-rich material may be fed into the vessel. Water may be added in a controlled ratio with the cellulose-rich material. The water is typically preheated. While the vessel is heated, a rapid depressurization may be imposed inside the vessel by an external vacuum system. The vacuum can be kept for a period. Then, the pressure is allowed to normalize according to the temperature, reaching the saturation temperature of water vapor at the desired pressure. Temperature control is achieved by pressure control, while the external heat source controls the heating rate. After the feedstock is kept at the desired temperature and pressure for the prescribed time, the vacuum system extracts vapor from the vessel. As the vessel heating is maintained, the moisture level of the processed material is controlled as more water is evaporated and extracted; thus, during this sub-step, the vessel operates as a vacuum dryer. Once the desired amount of water has been removed, and the moisture level of the reactor hold-up has reached the desired target, the vacuum system is disengaged, and the vessel is allowed to normalize to atmospheric pressure. A vapor recovery system may be utilized. The extracted vapor (primarily steam) is condensed, and the condensate is returned to a hold-up tank and stored for reuse. As the evaporation in the vessel may remove low-boiling volatile organic contaminants (VOCs) present in the feedstock, the aqueous stream leaving the vessel may be appropriately treated to remove such contaminants. For example, the condensate stream may be passed through an activated carbon bed where the organic contaminants are removed by absorption. Upon completion of the pretreatment, the material is discharged.

The material discharged from the reactor may be subjected to final screening, typically to remove non-organic material whose separation is easier now that most of the cellulosic material has been homogenized into a pulp or fluff-like material or separated organics. Such material may be sand, grit, and small residual metallic, plastic, and glass fragments.

The separated organics are fed into the polymer-solvent-biomass mixing unit (FIG. 2). Note that the MSW-derived material fed to this mixing unit may be waste cellulose-rich material (as the biomass component), or waste plastics (as the polymer component), or both waste cellulose-rich material and waste plastics. In some embodiments, substantially all of the cellulose-rich material from the MSW is used to make the densified composite, while only a portion of the waste plastics from the MSW are used. For example, the waste plastics may have been initially separated, such as via optical screening, and then a portion of those plastics added back to the cellulose-rich material. In certain embodiments, sorting of polymers is carried out on the waste plastics, to remove polymers (such as PVC or nylon) that are not preferred for making the densified composite, or for taking out certain polymers (e.g., polyethylene terephthalate, PET) that are to be recycled in a different manner, rather than used in the densified composite.

### EXAMPLES

### Example 1: Wood-PE-LDPE-HDPE Pellets

Table 1 shows relative heating values are shown for selected materials, including wood (pine softwood), B100 (biodiesel), PS (polystyrene polymer), LDPE (low-density polyethylene polymer), and HDPE (high-density polyethylene polymer). In Table 1, HHV is higher heating value, which represents the total heat released during the combustion of the material when the water combustion product is condensed to a liquid state at the same temperature as the reactants. LHV is lower heating value, which represents the amount of heat released by fully combusting the material, less the heat of vaporization of the water in the combustion product.

TABLE 1
High Heating Value (HHV) and Low Heating Value (LHV) of
Components of a Densified Solid Composite Fuel Pellet.

| Material | HHV (Btu/lb) | LHV (Btu/lb) |
|---|---|---|
| Wood (Pine) | 8,200 | 7,800 |
| B100 Biodiesel | 17,283 | 16,122 |
| PS | 17,492 | 16,630 |
| LDPE | 19,000 | 17,578 |
| HDPE | 19,000 | 17,664 |

TABLE 2
High Heating Value (HHV) and Low Heating Value (LHV)
of an Example Densified Solid Composite Fuel Pellet.

| | | HHV | LHV |
|---|---|---|---|
| Material | Concentration | (Btu/lb*) | (Btu/lb*) |
| Wood (Pine, 5 wt % moisture) | 94.0 | 7,275 | 6,918 |
| B100 Biodiesel | 3.0 | 518 | 484 |
| PS | 1.0 | 175 | 166 |
| LDPE | 1.0 | 190 | 176 |
| HDPE | 1.0 | 190 | 177 |
| Total | 100 | 8,349 | 7,921 |
| Increase vs. Pure Wood | | 14.8% | 14.5% |

*Pound (lb) of the entire composite pellet.

Table 2 shows the composition of an example densified solid composite fuel pellet. The biomass-polymer pellet contains 94.0 wt % softwood pine at 5 wt % moisture (therefore 89.3 wt % pine on a dry basis), 3.0 wt % biodiesel solvent, and 1 wt % each of polystyrene, low-density polyethylene, and high-density polyethylene. The total of polymers and solvent is 6 wt % in the pellet.

The inclusion of plastics (PS, LDPE, and HDPE) and biodiesel at 6% on a weight basis yields a 15% increase in heating value, which provides the pellet user a superior energy density for heating applications.

### Example 2: Wood-EPS Pellets

In this example, expanded polystyrene (EPS) is dissolved into biodiesel solvent at the 3 to 1 weight ratio. Once the EPS is thoroughly dissolved and the resulting fluid does not have identifiable suspended solid plastic particles, it is blended with reground pine wood saw dust, forming a wood-EPS-biodiesel mixture that contains about 96 wt % wood, about 3 wt % EPS, and about 1 wt % biodiesel.

Pelletizing is then conducted on a commercial 60-Hp pellet mill. The initial pellet die utilized has ¼″ hole die with an 8:1 (2 inches effective) compression ratio (compression ratio=die length divided by hole diameter). The initial starting moisture pre-pelletizing is 4.7 wt % moisture for the wood-EPS-biodiesel mixture. The preferred pelletizing moisture ranges from 12-15 wt % moisture before entering the pellet die. Because of the low moisture of the mixture, steam is utilized during the pelleting to improve pelletizing efficiency and reduce wear on the pellet-mill die. Wood-EPS pellets are recovered from the pellet mill. The final pellets after cooling contain about 5.3 wt % moisture.

Durability testing is carried out on the wood-EPS pellets, using the Kansas State Pellet Durability Index (PDI) score which prescribes tumbling 500 grams of cooled pellets in a durability tumbler for 10 minutes at 50 revolutions per minute. The wood-EPS pellets are then sieved according to their starting diameter, allowing fines to pass through. The retained wood-EPS pellets are weighed and a percent durability calculated, as shown in Table 3. The PDI for the example wood-EPS pellets is 97.6%. The density of these pellets is measured as 40.2 lb/ft₃.

Lastly, pellet sorbency is evaluated to characterize whether EPS inclusion into the pellet fuel provides hydrophobic characteristics to the composite, reduces hygroscopicity. Sorbency trials are conducted following ASTM F726-99; 9.3.2 Type II sorbents. The sorbency characteristics of the wood-EPS pellets are shown in Table 3 against a control made of wood pine (with no polymer or solvent).

TABLE 3
Properties of the Example 2 Wood-EPS Composite Pellets.

| Product | Durability | Density (lb/ft³) | Sorbency (g/g) |
|---|---|---|---|
| Composite Pellet | 97.6% | 40.2 | 5.45 |
| of Example 2 | | | |
| Control Pellet | 98.5% | 41.2 | 5.77 |
| (Pine) | | | |

This example shows that 4 wt % inclusion (collectively) of EPS and biodiesel results in a composite pellet produced with ease based on the observation that the exit temperature from the die is low. The addition of biodiesel solvent to the wood provides a lubricity effect when pelletizing. The final pellet moisture after cooling exceeds the Pellet Fuel Industry Standard of <8 wt %—that is, the measured moisture level is even lower than that constraint. The Example 2 composite pellet does have a slightly lower density compared to the control pellet, yet still adequately meets the Pellet Fuel Industry Standard for pellet fuel density. The pellet Durability Index score for the Example 2 composite pellet exceeds the Pellet Fuel Institute Standard of >96.5%. Finally, the Example 2 composite pellet has a slightly improved sorbency, compared to the control pellet.

### Example 3: Use of Antisolvent to Recover Polymer

In this example, expanded polystyrene (EPS) is dissolved into biodiesel solvent at the 3 to 1 weight ratio. Once the EPS is thoroughly dissolved and the resulting fluid does not have identifiable suspended solid plastic particles, it forms an EPS-biodiesel mixture. The EPS-biodiesel mixture may be added to biomass such as in Example 2, but in this example, the EPS-biodiesel mixture is not added to biomass.

An antisolvent, petroleum diesel, is added to the EPS-biodiesel mixture, at a weight ratio of 1 g/g (antisolvent to solvent), at about 25° C., and with gentle mixing. Almost immediately upon addition of the antisolvent, precipitated polystyrene becomes visible in the mixture. Precipitated polystyrene (EPS) is then recovered by simple separation—pouring the mixture through a screen.

In this detailed description, reference has been made to multiple embodiments and to the accompanying drawing(s) in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein. This disclosure hereby incorporates by reference U.S. Pat. No. 11,458,414, issued on Oct. 4, 2022; U.S. Pat. No. 8,034,132, issued on Oct. 11, 2011; and U.S. Pat. No. 7,497,392, issued on Mar. 3, 2009.

The embodiments, variations, and figure described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. A densified solid biomass-polymer composite comprising:
from about 50 wt % to about 98.5 wt % biomass;
from about 1 wt % to about 20 wt % polymer, wherein said polymer includes a single type of polymer or multiple types of polymers; and
from about 0.5 wt % to about 10 wt % solvent,
wherein said biomass, said polymer, and said solvent are intimately mixed together,
and wherein said densified solid biomass-polymer composite has a higher heating value of at least 8000 Btu/lb.

2. The densified solid biomass-polymer composite of claim 1, wherein said biomass is selected from the group consisting of hardwoods, softwoods, herbaceous biomass, agricultural crops, agricultural residues, grasses, municipal solid waste, post-consumer paper, post-consumer cardboard, and combinations thereof.

3. The densified solid biomass-polymer composite of claim 1, wherein said polymer is selected from the group consisting of polystyrene, polyethylene, polypropylene, and combinations thereof.

4. The densified solid biomass-polymer composite of claim 1, wherein said polymer is derived from a post-consumer plastic source.

5. The densified solid biomass-polymer composite of claim 1, wherein said solvent is one or more organic solvents selected from the group consisting of organic esters, ketones, alcohols, aromatics, cyclic alkanes, and combinations thereof.

6. The densified solid biomass-polymer composite of claim 1, wherein said solvent is selected from fatty acid methyl esters.

7. The densified solid biomass-polymer composite of claim 1, wherein said solvent contains biodiesel.

8. The densified solid biomass-polymer composite of claim 1, wherein said solvent consists essentially of biodiesel.

9. The densified solid biomass-polymer composite of claim 1, wherein said densified solid biomass-polymer composite contains about 8 wt % or less water moisture.

10. The densified solid biomass-polymer composite of claim 1, wherein said densified solid biomass-polymer composite contains about 4 wt % or less water moisture.

11. The densified solid biomass-polymer composite of claim 1, wherein said densified solid biomass-polymer composite has a higher heating value of at least 8250 Btu/lb.

12. The densified solid biomass-polymer composite of claim 1, wherein said densified solid biomass-polymer composite has a higher heating value of at least 8500 Btu/lb.

13. The densified solid biomass-polymer composite of claim 1, wherein said densified solid biomass-polymer composite is in the form of a biomass-polymer pellet.

14. The densified solid biomass-polymer composite of claim 13, wherein said biomass-polymer pellet has a pellet density of at least 40 lb/ft³.

15. The densified solid biomass-polymer composite of claim 1, wherein said densified solid biomass-polymer composite is in the form of a biomass-polymer briquette.

16. A method of making a densified solid biomass-polymer composite, said method comprising:
(a) providing biomass;
(b) providing a polymer, wherein said polymer includes a single type of polymer or multiple types of polymers;
(c) providing a solvent that is selected to at least partially dissolve said polymer in said solvent;
(d) mixing said biomass, said polymer, and said solvent in one or more mixing units to generate an intimately mixed material comprising said biomass, said polymer, and said solvent;
(e) feeding said intimately mixed material to a densification unit configured to densify said intimately mixed material into a densified solid biomass-polymer composite; and
(f) recovering said densified solid biomass-polymer composite.

17. The method of claim 16, wherein said biomass is selected from the group consisting of hardwoods, softwoods, herbaceous biomass, agricultural crops, agricultural residues, grasses, municipal solid waste, post-consumer paper, post-consumer cardboard, and combinations thereof.

18. The method of claim 16, wherein said polymer is selected from the group consisting of polystyrene, polyethylene, polypropylene, and combinations thereof.

19. The method of claim 16, wherein said polymer is derived from a post-consumer plastic source.

20. The method of claim 16, wherein said solvent consists essentially of biodiesel.

21. The method of claim 16, wherein a first mixing unit is employed to mix said polymer and said solvent to generate a polymer-solvent mixture, and a second mixing unit is employed to mix said biomass with said polymer-solvent mixture to generate said intimately mixed material.

22. The method of claim 16, wherein a single mixing unit is employed to mix said polymer, said solvent, and said biomass to generate said intimately mixed material.

23. The method of claim 16, wherein step (d) utilizes a mixing temperature selected from about 20° C. to about 200° C.

24. The method of claim 16, wherein said densification unit is a pellet mill, an extruder, or a briquetter.

25. The method of claim 16, wherein a binder is added to said densification unit, and wherein said binder is distinct from said biomass, said polymer, and said solvent.

26. The method of claim 16, wherein said densified solid biomass-polymer composite contains about 4 wt % or less water moisture.

27. The method of claim 16, wherein said densified solid biomass-polymer composite has a higher heating value of at least 8500 Btu/lb.

28. The method of claim 16, wherein said densified solid biomass-polymer composite is in the form of a biomass-polymer pellet.

29. The method of claim 16, wherein said biomass-polymer pellet has a pellet density of at least 40 lb/ft³.

30. The method of claim 16, wherein said densified solid biomass-polymer composite is in the form of a biomass-polymer briquette.
